(19) United States
(12) Patent Application Publication
(10) Pub. No.: US 2009/0066266 A1
(43) Pub. Date: Mar. 12, 2009

(54) INTEGRATED POWER AND CONTROL UNIT FOR A SOLID-STATE LIGHTING DEVICE

(75) Inventors: Paul Jungwirth, Burnaby (CA); Ozan Perincek, Western Australia (AU)

Correspondence Address: PHILIPS INTELLECTUAL PROPERTY & STANDARDS, 3 BURLINGTON WOODS DRIVE, BURLINGTON, MA, 01803, US

(73) Assignee: TIR TECHNOLOGY LP, Burnaby, BC (CA)

(21) Appl. No.: 12/297,733

(22) PCT Filed: Apr. 23, 2007
(86) PCT No.: PCT/CA2007/000677

§ 371 Date: Oct. 20, 2008

Related U.S. Application Data
(60) Provisional application No. 60/816,518, filed on Jun. 26, 2006.
(60) Provisional application No. 60/868,683, filed on Dec. 5, 2006.

(30) Foreign Application Priority Data
Apr. 21, 2006 (CA) 2,544,477

(51) Int. Cl. H05B 37/02

(52) U.S. Cl. 315/307

(57) ABSTRACT

The present invention provides an integrated power and control unit for use with a solid-state lighting device. The integrated power and control unit comprises a power input and a data input. The power input receives power from a power source, wherein this power is configured in a first power format and the data input receives control data from a control data source, wherein the control data is configured in a first data format. The integrated power and control unit further comprises a translation device coupled to the power input and the data input. The translation device is configured to convert the power in the first power format to power in a second power format and further configured to convert the control data in the first data format to control data in a second data format. The second power format and second data format are compatible with the required power and data formats of the solid-state lighting device and transmit the required power and data formats of the solid-state lighting device using a power and data output.

### FIELD OF THE INVENTION

The present invention pertains to the field of lighting and in particular to an integrated power and control device for a lighting device.

### BACKGROUND

Advances in the development and improvements of the luminous flux of light-emitting devices such as solid-state semiconductor and organic light-emitting diodes (LEDs) have made these devices suitable for use in general illumination applications, including architectural, entertainment, and roadway lighting. Light-emitting diodes are becoming increasingly competitive with light sources such as incandescent, fluorescent, and high-intensity discharge lamps.

Presently, a solid-state lighting device receives control data for the operation thereof. This control data is typically configured in a required format, for example DALI, DMX or other protocol as would be known. This control data is typically configured at the originating source in the required format associated with the solid-state lighting device being controlled. Therefore compatibility between the protocols being used at the originating source and the solid-state lighting device is required. This may result in a problem if an originating source is configured to use a particular protocol, and a solid-state lighting device to he controlled thereby requires control data having a different format. The solid-state lighting device would therefore need to be reconfigured or customized for multiple different possible control protocols, which would add components, cost and complexity to the lighting device.

Furthermore, depending on the deployment site of a particular solid-state lighting device, the power source may be configured in a variety of formats which may include voltage supply, current supply and frequency.

A number of publications describe how electrical power and control signals can be supplied to a lighting device. For example U.S. Patent Application Publication No. 2005/0289279 describes a system and a method for operating devices, for example luminaires, light dimmers and the like, which are used in entertainment lighting applications. Embodiments include a power supply operating a plurality of such devices coupled to selectively addressable outputs and having a converter of an industry-standard communication protocol (e.g., DMX512, RDM or ACN protocol) in a communication protocol compatible with such devices.

U.S. Pat. No. 6,847,316 provides a method of communicating a message between an automotive device of an automotive control area network and a non-automotive, industrial device of a non-automotive, field bus network. A field bus network is defined to be any data communications network specified by hardware and software protocols with formats native to the industrial device that are different from the protocols that specify the automotive control area network. The method includes receiving a message of a native format from either one of the automotive devices of the automotive control area network or one of the non-automotive, industrial devices of the non-automotive, field bus network; translating the original native message format to a common language format; processing the message of a common language format via a set of stored, configurable rules; translating the processed message of a common language format to the appropriate destination native message format; and delivering the message of destination native format to the desired automotive device or non-automotive, industrial device.

U.S. Pat. Nos. 6,664,745, 6,570,348 and 6,331,756 describe apparatuses for digital communications with multi-parameter light fixtures. A typical light fixture is an integral unit that has a lamp assembly and a communication node to control the lamp assembly. One type of lighting system has at least two communication systems that interconnect the light fixtures. A digital controller is connected to one of the communication systems, at least one of the light fixtures of that communication system is a designated gateway for sending control signals to the other communication system.

U.S. Pat. No. 6,292,901 describes methods and systems for powering a device, which include providing a data signal and extracting power from the data signal to power the device. The device may be either a device that responds to the data signal or another device. The data signal may vary between at least two data states and the methods and systems may extract power during one or both of the data states. The methods and systems may include a multiplexer and the controlled device may be an RS-485 compliant device, such as an LED system associated with a processor. The data signal may be a DMX-512 signal and the data signal may control a processor for control of the device.

U.S. Pat. Nos. 6,930,455, 6,020,825 and 5,668,537 describe a theatrical lighting control network which incorporates a local area network for communication among a number of node controllers and control consoles or devices employed in establishing lighting or other effect levels in a theatre, film production stage or other performance environment. Use of the network eliminates the requirements for the majority of hardwiring for interconnection of consoles and other controller or monitoring devices to effect controller racks and provides flexibility in location and relocation of various components of the system.

Similarly United States Patent Application Publication No. 2002/0181497 describes a protocol converter which appropriately converts communications directed from a device operating under a first protocol to a device operating under a second protocol. The converter is coupled to the two devices and converts communications between the devices into the appropriate format for the receiving device. The converter can include a programmable microprocessor which manipulates communications into the proper format for the receiving device and then transmits the manipulated communications to the receiving device. The converter can be coupled between two bus structures of different protocols, where one of the bus structures is an IEEE 1394-1995 bus structure. Alternatively, the converter and the devices are all coupled to the same bus structure. A protocol conversion program is preferably stored within a read only memory (ROM) and used by the microprocessor to perform the appropriate conversions. Alternatively, the programmable microprocessor is programmed for the appropriate conversions by a device coupled to the converter. To communicate with a device using a second protocol, a device using a first protocol sends the communication intended for the device using the second protocol to the protocol converter. After receiving a communication sent from a device using the first protocol, the protocol converter manipulates the communication into the appropriate format for the device using the second protocol. The manipulated communication is then transmitted to the device using the second protocol.

U.S. Pat. No. 5,898,801 describes a bi-directional, redundant, optical transport system that is configured to provide a non-blocking, bi-directional, multi-channel, protocol independent optical transport system for the simultaneous transfer of digital, analog, and discrete data between a plurality of data terminal equipment. The optical transport system includes a light transmission line for transmitting light bi-directionally and a plurality of nodes, connected in series by the light transmission line for receiving, extracting and passing signal light. Each node comprises data terminal equipment for issuing and receiving electrical signals and an electro-optical interface device, associated with the data terminal equipment, for converting electrical signals issued by the associated data terminal to signal light for insertion onto the light transmission line. The electro-optical device also converts signal light, extracted from the light transmission line into electrical signals to be received by the associated data terminal. Each node further comprises a translation logic device connected between the optical interface device and the data terminal equipment, for performing required protocol translation for the data terminal equipment. Each node also includes an optical interface device, connected to the electro-optical interface device and the light transmission line, for extracting signal light from the light transmission line to be converted into electrical signals by the electro-optical interface device for receipt by the data terminal equipment. The optical interface also inserts, onto the light transmission line, signal light received from the electro-optical interface device and passes signal light bi-directionally on the light transmission line.

U.S. Pat. No. 6,792,337 describes a power management architecture for an electrical power distribution system, or portion thereof. The architecture includes intelligent electronic devices (IEDs) configured with the capability to monitor and control attached slave devices and provide capability for the communication between multiple devices in a variety of communication protocols. A master IED in the master/slave architecture performs power management functions on the data received from the slave IEDs. Further, the IEDs with master functionality provide web server capabilities, allowing a user to view processed data over an open Internet Protocol, such as HTTP (Hyper Text Transfer Protocol).

U.S. Pat. No. 6,930,730 describes apparatuses, methods, and systems for centrally and uniformly controlling the operation of a variety of devices, such as communication, consumer electronic, audio-video, analog, digital, 1394, and the like, over a variety of protocols within a network system. This patent provides a control system and uniform user interface for centrally controlling these devices in a manner that appears seamless and transparent to the user. In an embodiment, a command center or hub of a network system includes a context and connection permutation sensitive control system that enables centralized and seamless integrated control of all types of input devices. The control system preferably includes a versatile icon based graphical user interface that provides a uniform, on-screen centralized control system for the network system. The user interface, which includes a visual recognition system, enables the user to transparently control multiple input devices over a variety of protocols while operating on a single control layer of an input command device.

U.S. Pat. No. 6,192,282 describes an improved building automation system which is modular in design thus minimizing the amount of instruction necessary to affect control of a particular building system. A relatively small set of inter-process control commands define an inter-process control protocol which is utilized in relatively high level scripts and control applications. The improved building automation system operates to translate control instructions in one particular control protocol to control instructions in a second control protocol. A text parsing program routes inter-process communication commands between modular communication programs to affect control over the automated building systems. The text parsing program includes executable instructions which allow for conditional communication of inter-process control commands depending upon system events.

United States Patent Application Publication No. 2004/0225811 describes an interface bridge between a standard input-output (I/O) computer port and a Digital Addressable Lighting Interface (DALI) interface. The DALI bridge translates signal levels and protocol from the standard I/O computer interface port to the DALI signal levels and protocol, and visa-versa. A digital processor is used for protocol translation and message buffering. Signal level translation is used to properly connect to a computer port and the voltage levels of the two-wire DALI bus. Use of a standard computer for testing and control of a DALI compliant device and/or plurality of DALI compliant devices in a building lighting system is facilitated by the DALI bridge.

European Patent No. 1,189,386 describes a network-adapted protocol conversion connector with a function for converting the protocol of control signals sent and received between an indoor high-functional network laid in office buildings or dwelling houses and low-functional network-adapted appliances such as a household electric appliance and an indoor communication network system using the connector. In an embodiment, the protocol conversion connector comprises a primary connecting portion to be connected to the communication network laid indoors, a secondary connecting portion to be connected to a network-adapted appliance, a protocol conversion interface to convert the protocol for control signals sent and received between the communication network and the network-adapted appliance, and a feeder connecting portion to feed electric power to the network-adapted appliance to be connected to the secondary connecting portion. More improved and extended connectors designed for use in power line carrier systems or wireless communication systems are also disclosed.

While there are devices and configurations for the conversion between communication protocols, there remains a need for an integrated power and control unit which can provide a solid-state lighting device with a required power and control data independent of power and control data supply.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an integrated power and control unit for a solid-state lighting device. In accordance with an aspect of the present invention, there is provided an integrated power and control unit adapted for use with a solid-state lighting device, the integrated power and control unit comprising: a power input for receiving power in a first power format, the power input adapted for connection to a source of power; a data input for receiving control data in a first data format, the data input adapted for connection to a source of control data; a translation device coupled to the power input and the data input, the translation device including a power conversion unit configured to convert the power in the first power format to power in a second power format and the translation device including a data conversion unit configured to convert the control data in the first data format to control data in a second data format; and a power and data output adapted for connection to the solid-state lighting device, the power and data output transmitting power in the second power format and control data in the second data format to the solid-state light device; thereby providing power and control data to the solid-state lighting device in a required format independent of the first power format and the first data format.

### BRIEF DESCRIPTION OF THE FIGURES

FIG. 1 is a front perspective view of an integrated power and control unit according to one embodiment of the present invention.

FIG. 2 is a rear perspective view of the integrated power and control unit of FIG. 1.

FIG. 3 is an exploded view of the integrated power and control unit of FIG. 1.

FIG. 4 is a block diagram of an integrated power and control unit according to one embodiment of the present invention.

FIG. 5A is perspective view of an integrated power and control unit according to another embodiment of the present invention with a data conversion unit removed.

FIG. 5B is perspective view of the integrated power and control unit of FIG. 8A with a data conversion unit installed.

FIG. 5C is another perspective view of the integrated power and control unit of FIG. 8A with a data conversion unit installed.

FIG. 6 is a front perspective view of an integrated power and control unit according to one embodiment of the present invention wherein a data conversion unit is removed.

FIG. 7 is an exploded view of the integrated power and control unit of FIG. 6.

FIG. 8A is an front perspective view of the integrated power and control unit of FIG. 6 with a data conversion unit.

FIG. 8B is an front perspective view of the integrated power and control unit of FIG. 6 with a data conversion unit installed.

FIG. 9 illustrates power conversion stages according to one embodiment of the present invention, which can be required to run a data conversion unit and further illustrates a connection mechanism which can combine a data conversion stage with a power conversion unit, according to one embodiment of the present invention.

FIG. 10 shows a processor according to one embodiment of the present invention, wherein the processor is configured to translate a first data format into a second data format.

FIG. 11 shows hardware circuitry according to one embodiment of the present invention, which can be used to convert incoming data signals to appropriate voltage levels required by the processor of FIG. 10.

FIG. 12 shows other hardware circuitry according to an embodiment of the present invention, which can be used to convert incoming data signals to appropriate voltage levels required by the processor of FIG. 10.

FIG. 13 shows other hardware circuitry according to an embodiment of the present invention, which can be used to convert incoming data signals to appropriate voltage levels required by the processor of FIG. 10 and FIG. 13 further illustrates hardware according to an embodiment of the present invention, which can be used to convert signals generated by the processor of FIG. 10 to appropriate voltage levels required by a solid-state lighting device.

FIG. 14 is a schematic representation of the power conversion unit according to one embodiment of the present invention, wherein input power connections, input power conversion stage, output power conversion stage, output power connections and input and output data connections are illustrated.

### DETAILED DESCRIPTION OF THE INVENTION

### Definitions

The term “light-emitting element” is used to define a device that emits radiation in a region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides an integrated power and control unit for use with a solid-state lighting device. The integrated power and control unit comprises a power input and a data input. The power input receives power from a power source, wherein this power is configured in a first power format. The data input receives control data from a control data source, wherein the control data is configured in a first data format. The integrated power and control unit further comprises a translation device coupled to the power input and the data input. The translation device is configured to convert the power in the first power format to power in a second power format. The translation device is further configured to convert the control data in the first data format to control data in a second data format. The second power format and second data format are compatible with the required power and data formats of the solid-state lighting device. The integrated power and control unit further comprises power and data output adapted for connection to the solid-state lighting device thereby enabling transmission of power and control data in required formats to the solid-state lighting device. In this manner the integrated power and control unit is capable of providing both power and control data to the solid-state lighting device in a required format independent of the power format and the control data format which is originally received by the integrated power and control unit.

### Power Input

The power input is configured to accept power in a variety of formats including direct current, pulsed current, alternating current and a current format integrated with data. For example with specific regard to alternating current type sources, the power input can be configured to accept power of a variety of voltages and frequencies.

In one embodiment of the present invention, the power input is configured to provide a releasable connection to a power supply cable. In another embodiment, a power supply main lead with a plug at its extremity can be hardwired to the integrated power and control unit via the power input.

In one embodiment of the present invention, the power input of the integrated power and control unit has a spring clamp terminal block enabling the connection of power supply cables for the provision of power. In an embodiment, the ends of the power supply cables are stripped before connection to the terminal block. In another embodiment, crimp-on terminals or screw terminals may be used for connection of the power supply cable to the terminal block.

In another embodiment, the power input of the integrated power and control unit can be configured as an industry standard power inlet, such as an International Electrotechnical Commission (IEC) panel mounting plug, which accepts a connector such as an IEC line socket. A worker skilled in the art would readily understand other formats of the input power which can be supplied to the integrated power and control unit and the required power input configuration for that format of input power.

### Data Input

The data input is configured to accept control data in a variety of formats including network transmission protocols and other protocols used for the operation of lighting devices. For example the data input can be adapted to accept control data in a DMX, DALI, 0-10V, 1-10V, RS-232, RS-485, RDM, proprietary protocol or other protocol format as would be known to a worker skilled in the art. The data input can be further capable of accepting direct input from a user wherein this direct input can define, for example, desired luminous flux and chromaticity of the output light from the solid-state lighting device by the use of manual controls for example.

In one embodiment of the present invention, manual control inputs can be configured in either a digital or analog nature for example switches, potentiometers or the like, which are coupled to the data input.

In one embodiment of the present invention, a cable whip extends from the integrated power and control unit, wherein the cable whip is configured as the data input. The cables of the cable whip can be connected to external cables carrying the control data with crimps, for example, or other connector format as would be known to a worker skilled in the art.

In another embodiment, the data input of the integrated power and control unit has a spring clamp terminal block for the connection of data supply cables enabling the provision of the control data.

In another embodiment, if the format of control data is predetermined, an industry standard connector for the predetermined control data format may be used. For example, if the control data is configured in a DMX format, a 5-pin XLR connector can be used as the data input.

### Translation Device

The translation device is configured to receive the control data from the data input and the power from the power input and convert the received format of the power and control data into formats that are compatible with the solid-state lighting device being controlled. The translation device further transmits these desired formats of the power and control data to the power and data output for subsequent transmission to the solid-state lighting device.

In one embodiment of the present invention the translation device is configured to accept power and control data configured in a known format and subsequently convert this known format of power and control data into the desired format of power and control data for operation of a solid-state lighting device or network or solid-state lighting devices to which the integrated power and control unit is connected.

In one embodiment of the present invention, the translation device is converting power and control data for the control of a network of solid-state lighting devices. Upon the conversion of the power and control data into a desired format for a specific solid-state lighting device of the network, the translation device can further associate an address with this power and control data, which identifies the specific solid-state lighting device. In this manner the correct power and control data, each in the desired format, can be sent to the specific solid-state lighting device in the network.

In one embodiment of the present invention, the one or more solid-state lighting devices are operatively coupled to a translation device and the one or more solid-state lighting devices are configured for the translation device to actively query the one or more solid-state lighting devices in order to automatically determine the required power and/or data formats which are required by the one or more solid-state lighting devices.

### Power Conversion Unit

The power conversion unit is configured to convert the received power format into a power format compatible with the solid-state lighting device being controlled.

In one embodiment, the power conversion unit may comprise one or more transformers and other hardware which can provide the adjustment of one or a combination of the voltage of the input power, the current of the input power and the frequency of the input power, into the desired power format.

In one embodiment of the present invention, the power conversion unit is configured to accept an input voltage and boost or amplify this input voltage to a predefined level which is selected to be higher than an expected input voltage level. This amplification of the input power is performed prior to conversion to the desired power format, which is required by the solid-state lighting device. This configuration of the power conversion unit can thus be able to accept a large range of voltages as the input power is converted after amplification to a predefined level.

During operation of the solid-state lighting device, the desired power format for the solid-state lighting device may change, depending on the mode of operation of the solid-state lighting device or depending on a requirement to operate the lighting device at desired efficiency level.

In one embodiment of the present invention the power conversion unit comprises hardware and/or firmware which is configured to automatically detect the format of the incoming power and appropriately adjust or reconfigure the power conversion process in order to enable the power conversion unit to translate the detected format of incoming power to a desired format of output power. For example, this detection and reconfiguration of the power conversion unit can be achieved by the translation unit receiving a feedback signal from the solid-state lighting device, wherein the feedback signal indicates the format of power required by the solid-state lighting device. In one embodiment, the feedback signal can be received from the solid-state lighting device upon provision of an initial level of output power to the solid-state lighting device, or shortly after power is provided to the solid-state lighting device.

In another embodiment, a feedback signal may be received in response to sending a query signal to the solid-state lighting device. For example, the translation device may initially supply 25V to a solid-state lighting device upon electrical connection thereto. The solid-state lighting device subsequently sends a signal to the translation device indicating that it requires only 23V. The power conversion unit of the translation device is subsequently automatically reconfigured in order that the power conversion unit provides the desired power format, namely power at a voltage of 23V.

As another example, the translation unit can send a query to a solid-state lighting device which specifically requests the solid-state lighting device to provide operational requirements, namely the power format required. This format of query can be similar to that of querying RFID tags for identification, location or other purposes, for example, as would be readily understood by a worker skilled in the art. In this configuration, both the translation unit and the solid-state lighting device are appropriately configured to enable this active querying, wherein this type of configuration would be readily understood by a worker skilled in the art.

In one embodiment of the present invention, the power conversion unit is a regulated power supply which is either a linear or a switched mode power supply. For example, the DC output voltage of the power conversion unit can be regulated by a feedback loop which can provide a feedback signal from the solid-state lighting device in order to set the DC output voltage provided by the power conversion unit. For example, different solid-state lighting devices, even ones which are nominally identical, will typically send different feedback signals corresponding to different forward voltage requirements, for example minimum forward voltage required by the various constituent light-emitting elements in the solid-state lighting device.

In an embodiment and for a desired efficiency, the power conversion unit can be configured to supply the minimum required voltage. The power conversion unit can be configured as a power supply for example buck, boost, buck-boost, sepic, flyback or other type of power supply as would be known to a worker skilled in the art. As is known in the art, these types of power supplies can accept a range of input power formats, such as DC, AC or pulsed. The output format of the power provided by the power conversion unit can be adjusted to a required voltage or current via a feedback signal from the solid-state lighting device.

In one embodiment, a power conversion unit is configured to convert a specific format of input power to the desired power format of output power. For example, the power conversion unit has a predetermined and non-reconfigurable conversion system therein, which is specifically designed to convert a specific input power to a specific output power. In this embodiment, a translation device can be configured to enable the interchanging of the power conversion unit associated therewith, thereby enabling the same translation device to be adaptable for translation of alternate formats of power to the desired power format. For example, all connections to a power conversion unit within this format of translation device are formed as releasable couplers, releasable connectors, or the like.

In one embodiment, the power conversion unit is constructed as a removable circuit board or module. For example, if a required power format is outside the range currently available from the power conversion unit, this power conversion unit can be replaced with another power conversion unit, which may be a power conversion unit configured on a replacement circuit board module, which is capable of providing the required power format. In one embodiment, the circuit board module can be chosen in order to substantially maximize the efficiency of power conversion for the particular types of input and output power formats required.

In another embodiment, when the power format to be converted has a data signal superimposed on it, the power conversion unit comprises a filter or other device configured to separate the control data signals from the power signal. In this embodiment, the extracted control data can subsequently be directed to the data conversion unit for subsequent conversion if required. Upon extraction of the control data, the power can be converted into the required power format as required by the solid-state lighting device.

### Data Conversion Unit

The data conversion unit is configured to convert the received data format of the control data into a data format, which is compatible with the solid-state lighting device being controlled.

The data conversion unit comprises one or more of firmware/software and hardware which are configured to translate a known data format of the input control data into a desired data format of the output control data. The data conversion unit comprises a processor or microcontroller for conversion of the control data, and is coupled to and capable of accessing memory, for example RAM, PROM, EPROM, EEPROM, or like memory as would be readily understood by a worker skilled in the art.

In one embodiment of the present invention, conversion parameters, for example in the format of an algorithm, are stored in memory for access by the processor or microprocessor thereby enabling the conversion process. For example, in memory can be stored conversion parameters for converting known formats of control data into the desired format of the control data. In addition, if the desired format of the control data may change, the memory can comprise conversion parameters for converting between a variety of data formats, for example but not limited to DALI to RDM, DMX to DALI, RDM to DALI, or conversion of a known data format to a proprietary data format.

In an another embodiment the conversion parameters can be stored in memory accessible by the processor or microprocessor and configured as a look-up table correlating known formats of control data with a corresponding desired format of control data.

In one embodiment of the present invention, the data conversion unit is configured with hardware that converts the first format of the control data received from the data input into signals that can be read and manipulated by a processor or microprocessor. For example the hardware can be a collection of circuitry for example amplifiers, level shifters, optocouplers, wireless transceivers, filters or other circuitry that preconditions the received control data for manipulation by the processor. The processor can subsequently be configured to extract the required control data from the signals received from the hardware. The processor can subsequently, based on a set of parameters determined from the correlation between the known first format of the control data and the desired format of the control data, convert the control data into the format compatible with the solid-state lighting device. In one embodiment, the desired format of the control data generated by the processor can be preconditioned by hardware, for example amplifiers, level shifters, optocouplers, wireless transceivers, filters or other circuitry, before it is output to the solid-state lighting device.

In one embodiment, a data conversion unit is configured to convert a specific format of input data to a specific desired format of output data. For example, the data conversion unit has a predetermined and non-reconfigurable conversion system therein, which is specifically designed to convert a specific input data format to a specific output data format. In this embodiment, a translation device can be configured to enable the interchanging of the data conversion unit associated with the particular translation device, thereby enabling the same translation device to be adaptable for translation of alternate formats of data. For example, all connections to a data conversion unit within this format of translation device, are formed as releasable couplers, releasable connectors, or the like. In this manner the data conversion unit can be interchanged so that the integrated power and control unit can be manually reconfigured to accept different input data formats without changing the solid-state lighting device, or altering the physical or electrical connections between the integrated power and control unit and the solid-state lighting device.

In an embodiment of the present invention the hardware and/or firmware of the data conversion unit is configured to automatically detect the format of the incoming control data and appropriately adjust or reconfigure the conversion process in order to enable the data conversion unit to translate the detected format of incoming control data to a desired format of control data. For example, upon identification of the input data format and the desired output data format, the data conversion unit, via the processor or microprocessor can access memory to upload the appropriate conversion algorithm or lookup table to enable the data conversion process.

In an embodiment of the present invention the hardware and/or firmware of the data conversion unit is configured to automatically detect the required format of the data output and appropriately adjust or reconfigure the data conversion process in order to enable the data conversion unit to translate the detected format of the output data relative to the known or detected format of the incoming data format. For example, this is achieved by receiving a feedback signal from the solid-state lighting device, wherein this feedback signal is indicative of the format of data required by the lighting device. This feedback signal can be transmitted to the translation device, and specifically the data conversion unit upon initial connection of the translation device to the lighting device or upon provision of an initial power level to the lighting device.

In an embodiment of the present invention, the translation unit can send a query to solid-state lighting device which specifically requests the solid-state lighting device to provide operational requirements, namely the data format required. This format of query can be similar to that of querying RFID tags for identification, location or other purposes, for example, as would be readily understood by a worker skilled in the art. In this configuration, both the translation unit and the solid-state lighting device are appropriately configured to enable this active querying, wherein this configuration would be readily understood by a worker skilled in the art.

In one embodiment of the present invention, the data conversion unit can be configured for multi-mode operation, for example “learning mode” and “operation mode”. For example, in “learning mode” the data conversion unit can be configured to detect incoming control data and evaluate the format thereof, thereby providing a means for the selection of the appropriate translation algorithm or look-up table for example, in order to translate the incoming control data into the desired format of control data. Upon identification of the format of the incoming control data, the data conversion unit can operate in for example, “operation mode” which can enable the data conversion unit to translate the incoming control data into the desired format.

In one embodiment of the present invention, the data conversion unit is configured to revert to “learning mode” from “operation mode” only after a predetermined time period during which it detects incoming data. During the period of “operation mode”, the data conversion unit can continue to identify data reception errors, wherein these data reception errors may indicate a possible change in data protocol. In this embodiment, the data conversion unit is not required to devote computational resources to continually examining the incoming control data in order to evaluate the format of the control data. For example, prior to the expiry of the time delay for reversion to “learning mode”, the data conversion unit can assume that the control data format which was previously determined continues to be valid. Furthermore, for example, when control data transmission has terminated prior to the expiry of the time delay, upon the arrival of new control data, the data conversion unit will assume that the previously determined control data format remains valid.

In one embodiment of the present invention, the data conversion unit can be configured to receive a control data format identifier prior to or during control data transfer. In this manner, the format of the incoming control data is defined and the data conversion unit is not required to perform an auto-detection procedure to evaluate the format or protocol of the incoming control data.

### Power and Data Output

The power and data output are the means by which the power in the desired power format and the control data in the desired data format are transmitted to the solid-state lighting device or network of solid-state lighting devices.

The configuration of the power and data output can be compatible with the means for transmission of the power and control data to the solid-state lighting device. For example the power-data output can be configured to enable wired or wireless transmission.

In an embodiment of the present invention, the power and data output are configured as two separate outputs. In another embodiment, the power and data output is configured as a single output, which transfers both power and data, both in a desired format.

In one embodiment of the present invention the power and data output is configured as a DC voltage output plus an RS-485 output.

### Housing

In one embodiment of the present invention the integrated power and control unit is enclosed by a housing which can provide physical and optionally environmental protection to the integrated power and control unit. The housing is configured with apertures enabling operative connection to the power input, data input and power-data output of the integrated power and control unit.

In one embodiment the housing includes fastening means for mounting of the unit.

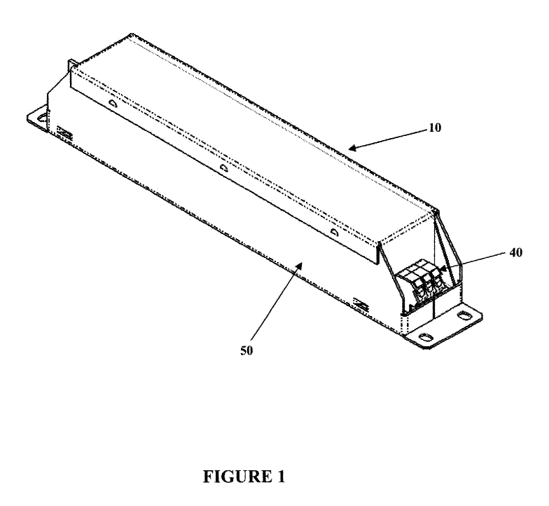

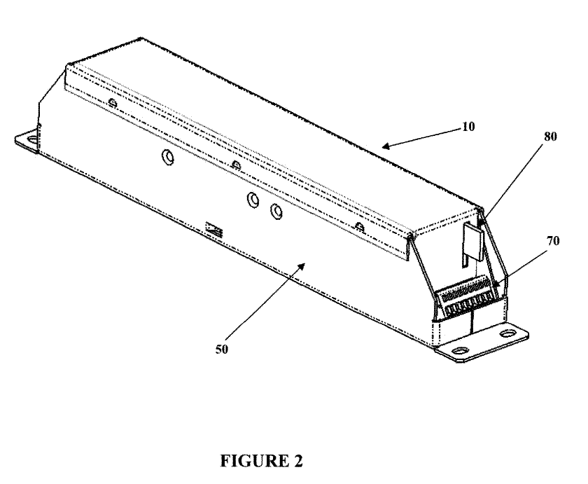

FIG. 1 and FIG. 2 illustrate front and rear perspective views, respectively, of the integrated power and control unit with a housing according to one embodiment of the present invention.

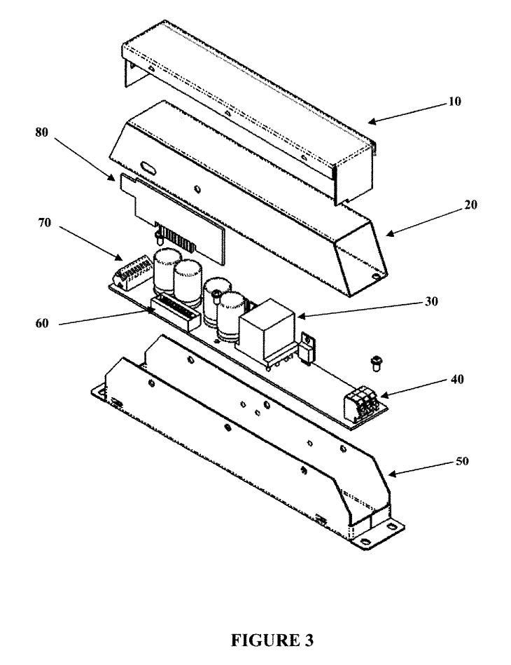

FIG. 3 is an exploded view of the front perspective view of FIG. 1. The housing is formed from three mating section 10, 20 and 30. The integrated power and control unit comprises a transformer 30 and other hardware and firmware which can provide power conversion. A data translator board 80 is coupled to a PCB by coupler 60, wherein the data translator board can provide the conversion of the control data into a desired data format. In addition, the power input 40 and data input are mounted on the PCB also as illustrated, wherein the power input and data input are operatively connected to the respective portions of the translation device.

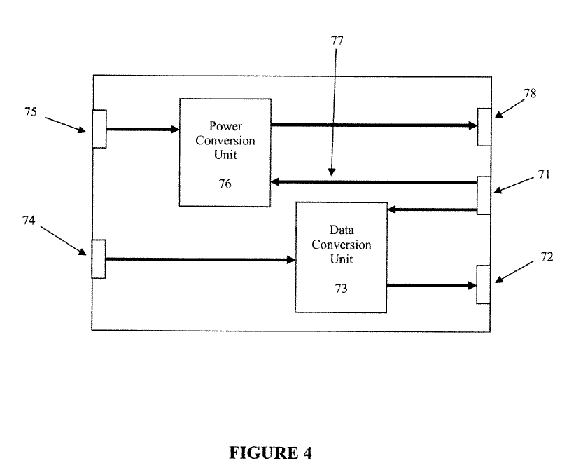

FIG. 4 shows a schematic representation of the integrated power and control unit according to an embodiment of the present invention. The lighting device (not shown) is connected to power output connector 78, data output connector 72 and feedback connector 71. The input power is connected to power input connector 75 and input data is connected to data input connector 74. The power conversion unit 76 converts the power from the input power format to the output power format. The data conversion unit 73 converts the input data format to the output data format. The signal specifying the desired output power format passes from the feedback connector 71 via internal connection 77 to the power conversion unit 76. Both the data conversion unit and power conversion unit can be configured to translate to and from multiple formats of power and data. The feedback connection provides information received from the lighting device wherein this information is indicative of the required power format, the required data format, or both.

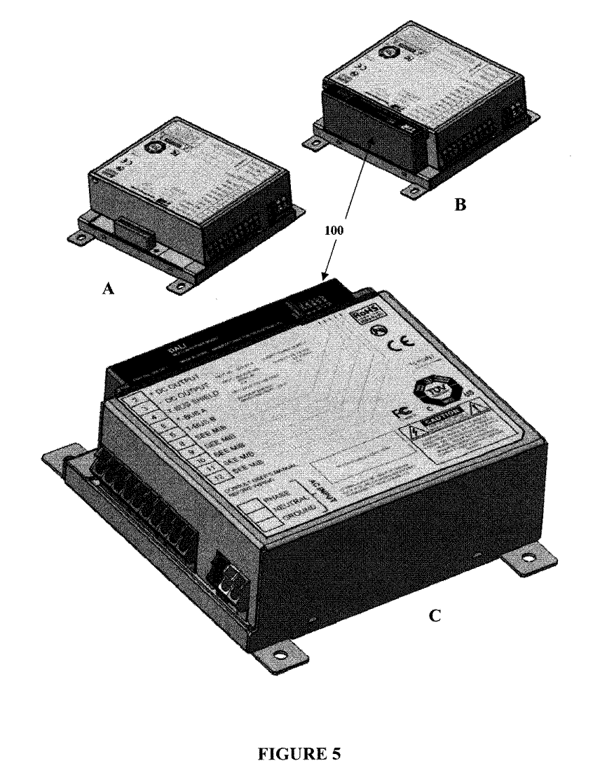

FIGS. 5A, 5B and 5C illustrate perspective views of an integrated power and control unit according to another embodiment of the present invention. FIG. 5A illustrates an integrated power and control unit with a data conversion unit removed therefrom, while FIGS. 5B and 5C illustrate the same integrated power and conversion unit with a data conversion unit 100 installed.

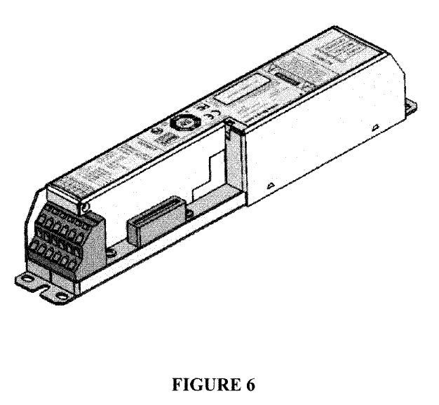

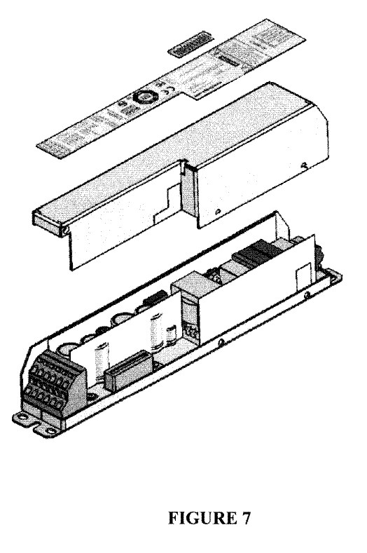

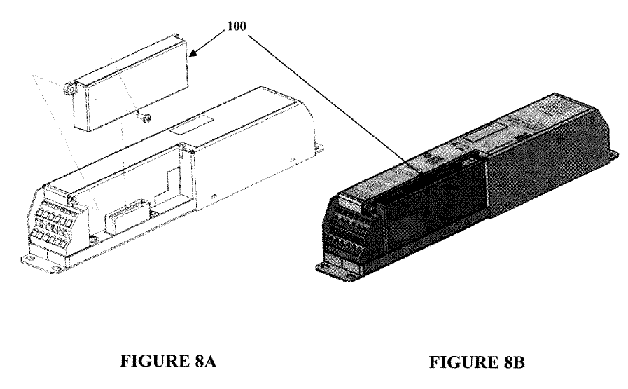

FIG. 6 is a front perspective view of an integrated power and control unit according to one embodiment of the present invention wherein the data conversion unit removed. FIG. 7 is an exploded view of the integrated power and control unit of FIG. 6. FIGS. 8A and 8B are front perspective views of the integrated power and control unit of FIG. 6 with the data conversion unit 101 installed therein.

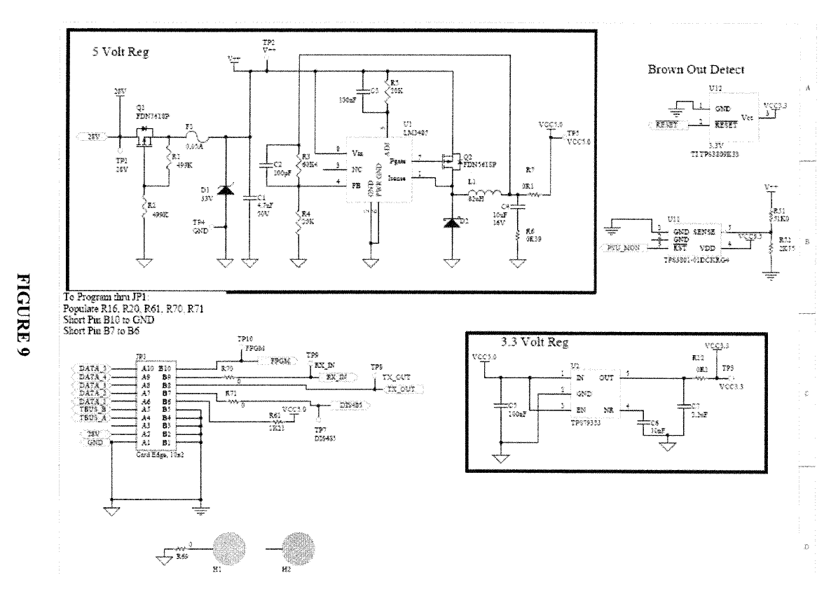

FIG. 9 illustrates power conversion stages which can be required to run the data conversion unit according to one embodiment of the present invention. FIG. 9 further illustrates a connection mechanism according to one embodiment of the present invention, which can enable interconnection between a data conversion stage and a power conversion unit.

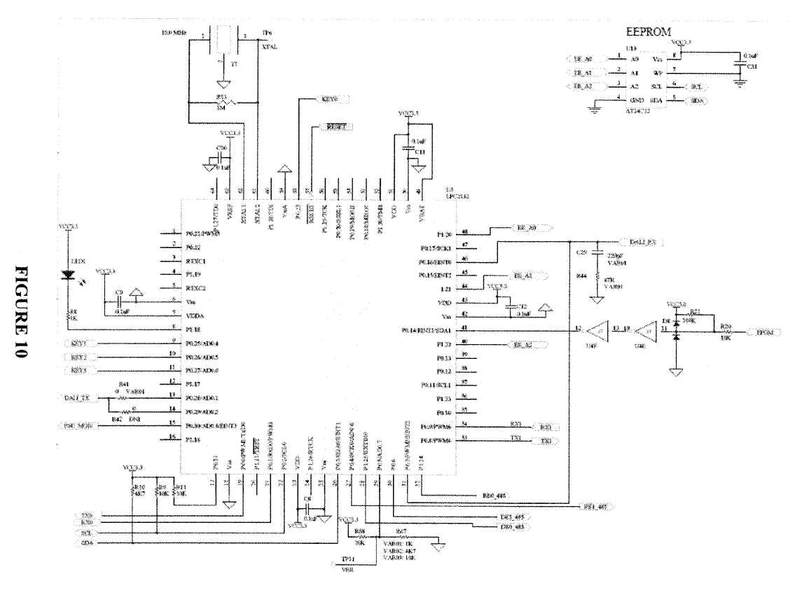

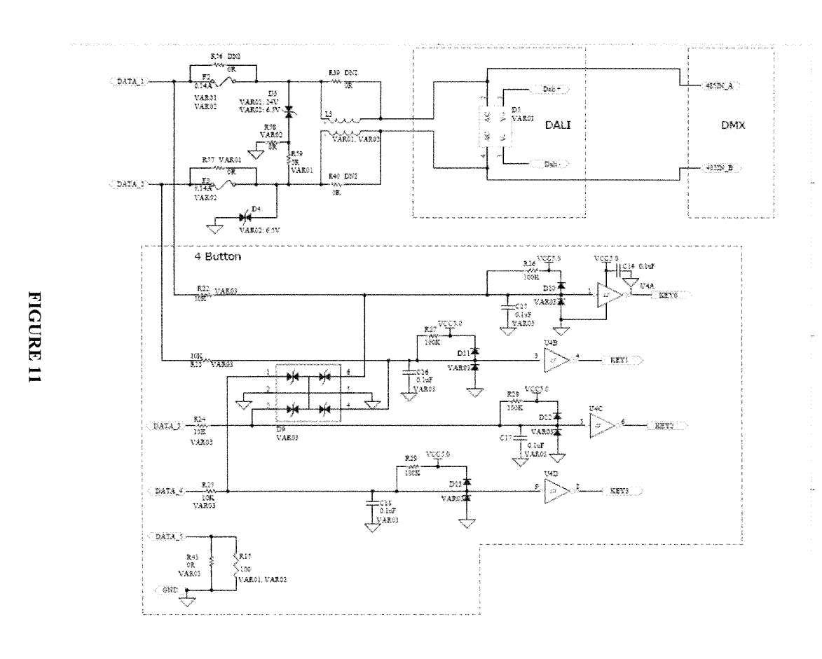

FIG. 10 illustrates processor schematics according to one embodiment of the present invention, wherein this processor is configured to translate the first data format into a second data format. FIG. 11 illustrates hardware circuitry according to one embodiment of the present invention, which can be used to convert incoming data signals to appropriate voltage levels required by the processor illustrated in FIG. 10.

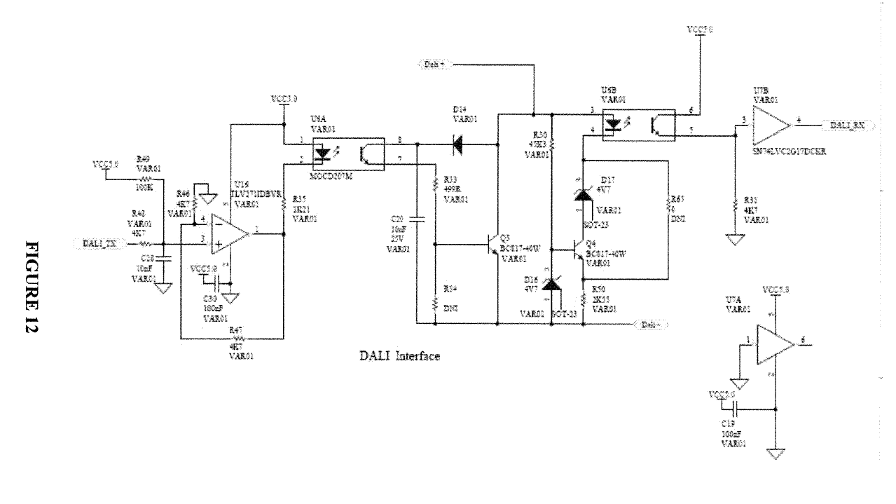

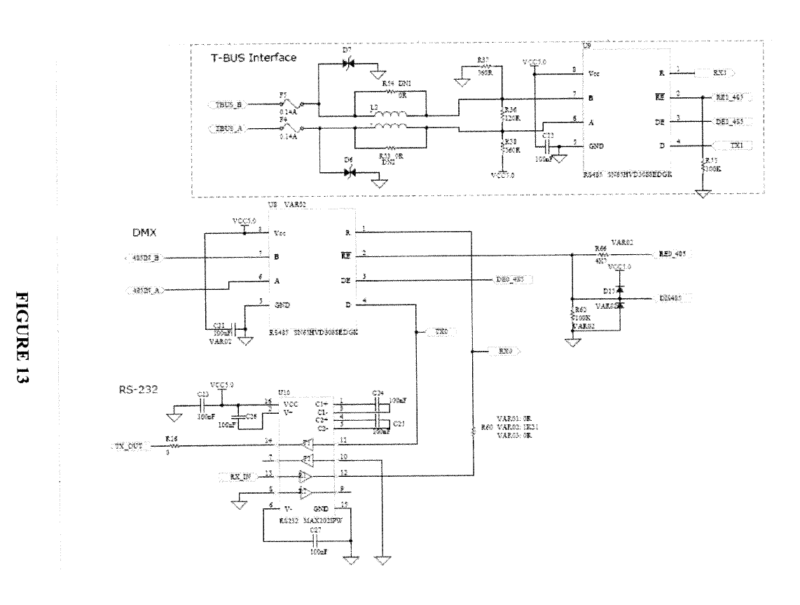

FIG. 12 illustrates other hardware circuitry according to one embodiment of the present invention, which can be used to convert incoming data signals to appropriate voltage levels required by the processor of FIG. 10. And FIG. 13 illustrates other hardware circuitry according to an embodiment of the present invention, which can be used to convert the incoming data signals to the appropriate voltage levels required by the processor of FIG. 10. Also illustrated in FIG. 13, is hardware according to an embodiment of the present invention, which can be used to convert signals generated by the processor of FIG. 10 to appropriate voltage levels which are required by the solid-state lighting device to which the integrated power and control unit is operatively coupled.

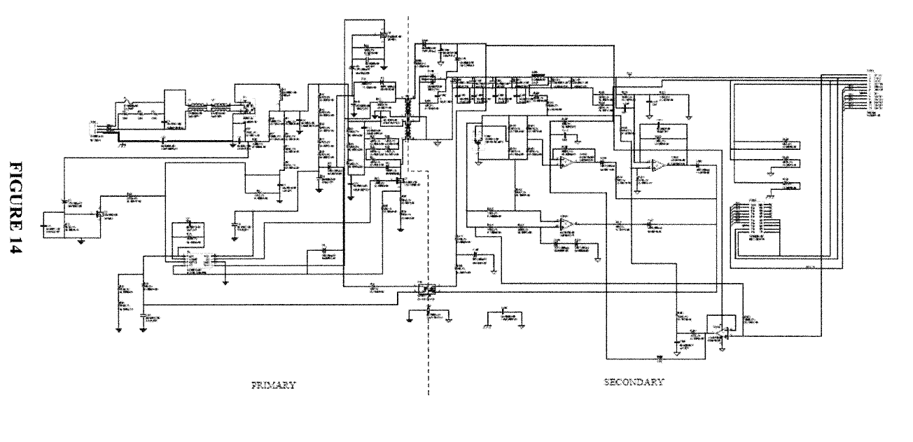

FIG. 14 is a schematic representation of a power conversion unit according to one embodiment of the present invention, wherein this figure illustrates input power connections, input power conversion stage, output power conversion stage, output power connections and input and output data connections according to one embodiment of the present invention.

### Solid-State Lighting Device

Solid-state lighting devices can comprise solid-state luminaires. A solid-state luminaire can comprise one or more groups of one or more light-emitting elements, wherein each group can comprise light-emitting elements of the same nominal color. The different colours can be a combination of one or more of red, green, blue, amber or other colours of light-emitting elements desired. Solid-state lighting devices can generate light having a chromaticity that is within the gamut of the light-emitting elements integrated into the lighting device. In order to control the light generated by solid-state lighting device it is necessary to control the amount of light generated by each light-emitting element or by each of the groups of light-emitting elements. A controller within the solid-state lighting device can receive control data configured in a required format in order to determine the desired operational characteristics of the groups of one or more light-emitting elements. The controller can be subsequently responsive to this control data and provide control signals to the one or more groups of one or more light-emitting elements thereby controlling the operation thereof, and therefore controlling the luminous flux and chromaticity of the light output by the lighting device.

One or more solid-state lighting device can be configured to form a lighting network. A solid-state lighting network protocol can control the operating conditions of the lighting devices in the lighting network. Provided that the luminaires in a lighting network can be effectively addressed, the solid-state lighting network protocol can be implemented by means of one or more master controllers. The network can be established by means of a wired or wireless communication network with a data transmission protocol, for example DALI, DMX, a proprietary protocol or other suitable communication protocol as would be known to a worker skilled in the art.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

1. An integrated power and control unit adapted for use with a solid-state lighting device, the integrated power and control unit comprising:
(a) a power input for receiving power in a first power format, the power input adapted for connection to a source of power;
(b) a data input for receiving control data in a first data format, the data input adapted for connection to a source of control data;
(c) a translation device coupled to the power input and the data input, the translation device including:
i. a power conversion unit configured to convert the power in the first power format to power in a second power format, and
ii. data conversion unit configured to convert the control data in the first data format to control data in a second data format; and
(d) a power and data output adapted for connection to the solid-state lighting device, the power and data output transmitting power in the second power format and control data in the second data format to the solid-state light device; thereby providing power and control data to the solid-state lighting device in a desired format independent of the first power format and the first data format.

2. The integrated power and control unit according to claim 1, wherein the power conversion unit is configured to amplify the first power format to a predetermined voltage level prior to conversion to the second power format.

3. The integrated power and control unit according to claim 1, wherein the power conversion unit comprises hardware and/or firmware configured to automatically identify the first power format.

4. The integrated power and control unit according to claim 3, the power conversion unit is configured to reconfigure a power conversion process at least partially based upon identifying the first power format.

5. The integrated power and control unit according to claim 1, wherein the translation unit queries the solid-state lighting device for operational parameters.

6. The integrated power and control unit according to claim 5, wherein the operational parameters includes the first power format.

7. The integrated power and control unit according to claim 1, wherein the power conversion unit is configured to convert a first predetermined power format to a second predetermined power format.

8. The integrated power and control unit according to claim 7, wherein the power conversion unit is configured as a module or circuit board capable of replaceable interconnection with the integrated power and control unit.

9. (canceled)

10. The integrated power and control unit according to claim 1, wherein the power conversion unit is a linear regulated power supply or a switched mode regulated power supply.

11. The integrated power and control unit according to claim 1, wherein the data conversion unit comprises a memory having conversion parameters stored therein.

12. The integrated power and control unit according to claim 11, wherein the conversion parameters are one or more algorithms, each defining a correlation between a first data format and a second data format, or one or more lookup tables, each defining a correlation between a first data format and a second data format.

13. (canceled)

14. The integrated power and control unit according to claim 1, wherein the data conversion unit comprises hardware and/or firmware configured to automatically identify the first data format.

15. The integrated power and control unit according to claim 14, the data conversion unit is configured to reconfigure a data conversion process based upon automatically identifying the first power format

16. (canceled)

17. The integrated power and control unit according to claim 1, wherein the data conversion unit is configured to convert a first predetermined data format to a second predetermined data format.

18. The integrated power and control unit according to claim 17, wherein the data conversion unit is configured as a module or circuit board capable of replaceable interconnection with the integrated power and control unit.

19. The integrated power and control unit according to claim 1, wherein the data conversion unit is configured to operate in a first learning mode and a second operating mode, wherein while operating in the first learning mode the data conversion unit is configured to identify the first data format.

20. The integrated power and control unit according to claim 19, wherein the data conversion unit is configured to revert to first learning mode from the second operating mode after a predetermined time period.

21. (canceled)

22. (canceled)

23. (canceled)

24. (canceled)
